(19) United States
(12) Patent Application Publication
(10) Pub. No.: US 2015/0163198 A1
(43) Pub. Date: Jun. 11, 2015

(54) METHODS AND APPARATUS FOR PROVIDING CONTROLLED UNIDIRECTIONAL FLOW OF DATA

(71) Applicant: Futaris, Inc., Anchorage, AK (US)

(72) Inventors: Gregory D. Moore, Anchorage, AK (US); Lara H. Baker, Anchorage, AK (US)

(21) Appl. No.: 14/564,806

(22) Filed: Dec. 9, 2014

Related U.S. Application Data
(60) Provisional application No. 61/914,286, filed on Dec. 10, 2013.

(51) Int. Cl. H04L 29/06

(52) U.S. Cl. CPC H04L 63/029

(57) ABSTRACT

Systems, methods, and apparatus that allow a controlled unidirectional flow of information between a source network and a destination network, and do not allow a flow of information from the destination network to the source network or any other network, thereby providing an unobservable and/or undetectable destination network, accessible only by a singular permitted flow of information. In addition, transformation of the data block of information is can be performed. Other functions can be performed on the data blocks. The options for transformations and/or functions are expandable, such that options can be added or removed. Log files can be generated at one or more points. The log files can be configured to comply with a desired format and/or standard.

### RELATED APPLICATIONS

This application claims priority to U.S. Provisional Patent Application No. 61/914,286, titled METHOD AND APPARATUS FOR PROVIDING CONTROLLED UNIDIRECTIONAL FLOW OF DATA, filed May Dec. 10, 2013, which is hereby incorporated herein by reference in its entirety.

### TECHNICAL FIELD

The present disclosure is directed generally to information networks, and more particularly to maintaining network security by providing a controlled unidirectional flow of data.

### BRIEF DESCRIPTION OF THE DRAWINGS

Understanding that drawings depict only certain preferred embodiments and are not therefore to be considered to be limiting in nature, the preferred embodiments will be described and explained with additional specificity and detail through the use of the accompanying drawings.

FIG. 1 is a functional block diagram of a Flow Diode according to one embodiment.

FIG. 2 is a functional block diagram of the computer and operating system topology and software resources of the Flow Diode according to one embodiment.

FIG. 3 is a Flow Diode, Input-Transformation-Output Summary diagram for a sender node, according to one embodiment.

FIG. 4 is a Flow Diode, Input-Transformation-Output Summary diagram for a low diode node, according to one embodiment.

FIG. 5 is a Flow Diode, Input-Transformation-Output Summary diagram for a high diode node, according to one embodiment.

FIG. 6 is a Flow Diode, Input-Transformation-Output Summary diagram for a receiver node, according to one embodiment.

### DETAILED DESCRIPTION OF PREFERRED EMBODIMENTS

Basic infrastructure supports modern society. Infrastructure may include structures, services, facilities, and the like, such as roads, bridges, water supply, sewers, electrical grids, and telecommunications, that facilitate production or provision of goods (e.g., commodities) and services that that can enable, sustain, or enhance societal living conditions and that enable an economy to function and further develop and grow. Infrastructure also facilitates industrial processes to produce goods and the distribution of finished products to markets. Infrastructure also enables provision of basic social services, such as schools and hospitals.

Many elements of infrastructure may operate on, be controlled over, and/or otherwise involve a data communication network. For example, control systems (e.g., industrial control systems (ICS)) are often found in infrastructure elements and/or industrial sectors, including but not limited to electrical, water, oil, gas, and data, and include data networks. Control systems are responsible for activating and monitoring industrial or mechanical controls. Many devices are integrated with computer networks (or other platforms) to control valves and gates to certain physical infrastructures. Data may be communicated over a network from remote stations and received to determine automated or operator-driven supervisory commands that can then be communicated back over the network to remote station control devices or field devices. These field devices may control local operations such as opening and closing valves and breakers, collecting data from sensor systems, and monitoring the local environment for alarm conditions.

Examples of control systems used in industrial applications and/or infrastructure applications include supervisory control and data acquisition (SCADA) systems, distributed control systems (DCS), and other smaller control system configurations such as programmable logic controllers (PLC).

Typical applications where SCADA systems perform real-time control include public utility systems (electricity, water supply, and flood control), transportation (airports, highways, and harbors), energy (smart grid systems, and petroleum product pipeline, storage, and distribution), atomic energy plants, health care (hospitals, clinics, and first responders), police, and military systems.

SCADA systems and other control systems in certain applications, such as infrastructure applications, may be expected to function reliably on a continuous basis without interruption. The level of reliability and/or availability expected may vary. In some applications, SCADA systems (or other control systems) must always function reliably on a continuous basis without interruption.

With the proliferation of the Internet and World Wide Web, there is a trend to couple control systems (e.g., ICSs) to the Internet and/or other networks coupled to the Internet, for example to leverage and utilize the information, accessibility, and computing power of these larger networks. While control systems are usually designed as remote telemetry devices, more and more control systems are linked to other physical devices through Internet access or modems.

Generally, relatively little security can be offered for the control system devices and other linked devices, thereby enabling many hackers and/or cyberterrorists to seek out system vulnerabilities. As a result, cyberterrorism and/or cyberwarfare are on the rise. Cyberterrorism may involve the use of computer network tools to shut down critical national infrastructures, for example to coerce or intimidate a government or civilian population. Cyberwarfare utilizes techniques of defending and attacking information and computer networks, often through a prolonged series of related campaigns, employing technological instruments of war to attack an opponent's critical computer systems. Ultimately, the result of both cyberwarfare and cyberterrorism is to damage critical infrastructures and computer systems. These cyber security concerns are increasingly important as the number of attacks and the number of successful attacks are on the rise.

In an effort to address cyber security concerns, there have been efforts to advance network security requirements and practices. Recently released security requirements include the protection of large computer network-based SCADA systems to support advanced Operations Administration and Management (OA&M) practices on mission-critical networks having lifeline functions.

New security practices for SCADA systems include physical segregation, electronic segregation, network domain segregation, and elevated physical and electronic security practices. The new practices include formal performance and security certification, and periodic audits of performance. The new practices include new standardized secure software code practices (e.g., Computer Emergency Response Team (CERT)) and certification laboratories which test new software for compliance. The new practices include the emergence of network security standards (ITIL, ISA-IEC, IETF RFC, ISA-ANSI, NERC, NIST, and ISO).

Near-future development of security practices may include formal data-via-network coordination between security devices (firewall, IDS, and diode) and new security standards.

The efforts and resources directed to addressing cyber security concerns suggest and demonstrate that systems, methods, apparatus, and devices for securing critical networks, such as infrastructure control systems, are desirable.

Presently, information diodes are used to protect high-security networks, including networks containing classified information, such as classified databases, as commonly found on federal government systems. These existing information diodes are limited to applications where the network connections to the information diodes are metallic, and have a capacity of 10 Mbps to 100 Mbps with Ethernet framing. These existing information diodes can protect large volumes of restricted data and can protect a system of high security from a system of low security by providing a unidirectional flow of information—e.g., from low security to high security—but provide little additional control of information flow.

By contrast, the embodiments of the present disclosure may be configured to specifically protect very large, very fast real-time SCADA systems on networks which use optical fiber media and have access bandwidths of up to 100 Gbps. The disclosed embodiments may also employ the principle of one-way information flow. However, the scope of the presently disclosed embodiments is larger and enables protection of systems of dissimilar security status (low-to-high, high-to-low), and similar security status (e.g., high and high). The disclosed embodiments are agile, in that they are capable of short-term implementation of new security capability. The disclosed embodiments can also provide a new granular forensic audit capability to meet the requirements of new standards as they emerge.

Embodiments disclosed herein provide apparatus and/or methods for maintaining security of computer systems and networks. The disclosed embodiments may enable compliance with recently emerged requirements. For example, the disclosed embodiments may include an information diode apparatus that can maintain a provably high level of security for a specialized computer network having mission-critical and lifeline command and control functions. The specialized computer network may be interconnected by either copper cable links or optical fiber links with data rates up from 10 Mbps (copper) to 100 Gbps (optical).

The disclosed embodiments can be configured specifically to meet the elevated security needs of those computer networks which exercise command and control of mission-critical systems providing real-time lifeline services, are interconnected over very fast optical fiber media, and require adaptability to changing standards and changing attacks.

Further, the disclosed embodiments can be used to provide a singular controlled unidirectional flow of information from a network of low security to a network of high security. The aspect of singular flow may refer to a single packet at a time. The aspect of controlled flow may refer to filtering and granularity, such as TCP windows and/or sliding windows. The disclosed embodiments may also be used to provide a like flow of information between networks of the same level of security. The disclosed embodiments may also be used to provide a flow of very restricted information from a network of high security to a network of low security.

Embodiments and implementations of the systems and methods described herein may include various steps, which may be embodied in machine-executable instructions to be executed by a computer system. A computer system may include one or more general-purpose or special-purpose computers (or other electronic devices). The computer system may include hardware components that include specific logic for performing the steps or may include a combination of hardware, software, and/or firmware.

Embodiments may be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD-ROMs, DVDs, ROMs, RAMs, EPROMs, EEPROMs, magnetic or optical cards, solid-state memory devices, or other types of media or computer-readable media suitable for storing electronic instructions.

Computer systems and the computers in a computer system may be connected via a network. Suitable networks for configuration and/or use as described herein include one or more local area networks, wide area networks, metropolitan area networks, and/or Internet Protocol (IP) networks, such as the World Wide Web, a private Internet, a secure Internet, a value-added network, a virtual private network, an extranet, an intranet, or even stand-alone machines which communicate with other machines by physical transport of media. In particular, a suitable network may be formed from parts or entireties of two or more other networks, including networks using disparate hardware and network communication technologies.

One suitable network includes a server and one or more clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

Suitable networks may include communications or networking software, such as the software available from Novell, Microsoft, and other vendors, and may operate using TCP/IP, SPX, IPX, and other protocols over twisted pair, coaxial, optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Each computer system includes one or more processors and/or memory; computer systems may also include various input devices and/or output devices. The processor may include a general purpose device, such as an Intel®, AMD®, or other “off-the-shelf” microprocessor. The processor may include a special purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, DVD, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, RAM, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, PHP, .Net, SQL and other database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, etc., that perform one or more tasks or implement particular data types. It is appreciated that a software module may be implemented in hardware and/or firmware instead of or in addition to software. One or more of the functional modules described herein may be separated into sub-modules and/or combined into a single or smaller number of modules.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available to persons of ordinary skill, such as general purpose computers, computer programming tools and techniques, computer networks and networking technologies, digital storage media, authentication, access control, and other security tools and techniques provided by public keys, encryption, firewalls, and/or other means.

The embodiments of the disclosure are described below with reference to the drawings, wherein like parts are designated by like numerals throughout. The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. That is, this disclosure includes every combination and permutation of the various embodiments and functionalities described herein, including permutations and combinations that are mutually exclusive inasmuch as they may be harmonized and/or used at discrete time intervals.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor do the steps need to be executed only once.

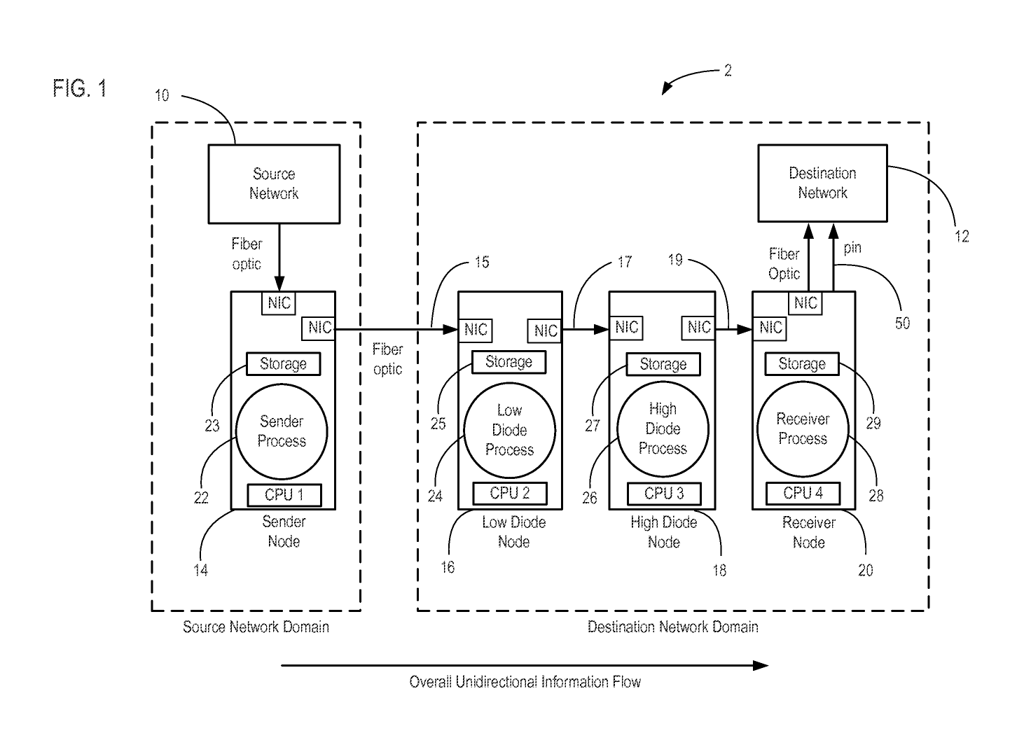

FIG. 1 is a functional block diagram of a system 2 (or “Flow Diode”), according to one embodiment of the present disclosure, for providing controlled unidirectional flow of data between a source network 10 and a destination network 12. The source network 10 may be a network of low security, such as the Internet, or a network of a corporate public utility. The destination network 12 may be a network of high security, such as a corporate SCADA system, for example, for control of public power generation and distribution. The Flow Diode 2 is positioned between the source network 10 and the destination network 12. The Flow Diode 2 separates (e.g., isolates) the destination network 12 from the source network 10.

The Flow Diode 2 may include four nodes 14, 16, 18, 20, which are represented in FIG. 1 as a sender node 14, a low diode node 16, a high diode node 18, and a receiver node 20. The sender node 14 may also be referred to as a source relay node. The low diode node 16 may also be referred to as a source diode node. The high diode node 18 may also be referred to as a destination diode node. The receiver node 20 may also be referred to as a destination relay node. Each of the four nodes 14, 16, 18, 20 may be or may include a processor or CPU, such as CPU 1, CPU 2, CPU 3, and CPU 4, respectively. Each of the four nodes 14, 16, 18, 20 may be implemented as an integrated circuit or chip or may include a more complex computing device such as a computer. The four nodes 14, 16, 18, 20 may include a storage device 23, 25, 27, 29.

The four nodes or processors 14, 16, 18, 20 may be interconnected via three network links 15, 17, 19 to form the Flow Diode 2. The links 15, 17, 19 may be of an appropriate material to provide physical connection. For example, the links 15, 17, 19 may be either copper cable links or optical fiber links with data rates up from 10 Mbps (copper) to 100 Gbps (optical). In other embodiments, one or more of the links 15, 17, 19 may be wireless.

The four processors 14, 16, 18, 20 and three connecting network links 15, 17, 19 are arranged and configured to allow movement of information in a single direction: from the source network 10 to the destination network 12. To isolate the destination network 12 from the source network 10, such as during a cyber-attack, a link between two of the nodes 14, 16, 18, 20 can easily be removed. For example, removal of the link 17 between the low diode node 16 and the high diode node 18 provides unambiguous certainty of the security of the destination network 12 against a cyber-attack.

The unidirectional flow of data begins when a computing device (e.g., a computer) on, within, or coupled to the source network 10 sends a block of data (e.g., a file) or other information to a computing device or other destination on, within, or coupled to the destination network 12. The computing device on the source network 10 is not aware, and cannot be aware, of any particular computing device on the destination network 12, but simply is able to send the block of data to the Flow Diode 2. The data may be received by the Flow Diode 2 at the sender node 14, such as in an export directory on or accessible by the sender node 14. Upon arrival in the export directory, the block of data may be processed by a sender process 22 and may be automatically sent from the sender process 22 to a low diode process 24 that may be executed or otherwise performed on the low diode node 16. The block of data may be processed by the low diode process 24 and/or may be automatically sent from the low diode process 24 to a high diode process 26 that may be executed on or otherwise performed by the high diode node 18. The block of data may be processed by the high diode process 26 and/or may be automatically sent from the high diode process 26 to a receiver process 28 that may be executed on or otherwise performed by the receiver node 20. The block of data may be processed by the receiver process 28 and/or may be automatically deposited in an import directory on or accessible by the receiver node 20.

Upon arriving at the receiver node 20 and/or the import directory, the block of data arrives in the high-security destination network 12. No signaling of any kind is sent in the reverse direction, from the destination network 12 to the source network 10. Lacking any returned signaling, the source network 10 cannot “see” the destination network 12. The source network 10 does not and cannot obtain data or information or otherwise “learn” anything from the destination network 12.

The receiver node 20 may be configured to restrict or even prevent execution, if possible, of the block of data. In other words, the transmitted block of data is prohibited from executing. For example, operating system configuration of the receiver node 20 may prevent execution, if that is possible, of the data block within the import directory.

Even if the data block could execute on the receiver node 20 or within the import directory, there exists no transmission path (e.g., the Flow Diode 2 provides no transmission path) back to the source network 10. For example, the receiver node 20 is incapable of transmitting data back to the high diode node 18, the high diode node 18 is incapable of transmitting data back to the low diode node 16, and the low diode node 16 is incapable of transmitting data back to the sender node 14. The unidirectional flow of information results in a predictable deterministic state of security for the destination network 12. Due to the lack of a logical communications channel from the destination network 12 back to the source network 10, it is not physically possible to receive any information from the destination network 12 back to the source network 10.

The unidirectional flow of information is segmented into three network link hops inside the Flow Diode 2: a first network link hop via first network link 15 from the sender process 22 on the sender node 14 to the low diode process 24 on the low diode node 16, a second network link hop via second network link 17 from low diode process 24 on the low diode node 16 to the high diode process 26 on the high diode node 18, and a third network link hop via third network link 19 from the high diode process 26 on the high diode node 18 to the receiver process 28 on the receiver node 20. The sender node 14 and any process thereon is not aware of any computing device beyond or downstream of the low diode node 16 in the direction of the flow of information through the Flow Diode 2. The sender node 14 cannot “see” over a network any further downstream than the low diode node 16. Similarly, the low diode node 16 is not aware of any computing device beyond or downstream of the high diode node 18 in the direction of the flow of information. Also, the high diode node 18 is not aware of any computing device beyond or downstream of the receiver node 20 in the direction of the flow of information.

The sender node 14 may manage the first hop via the first link 15. The sender node 14 may be permitted (e.g., by software configuration) to use the TCP/IP continuity test facility Packet Internet Groper (PING) to test continuity to the far end of the first hop, for example at a facing network interface (e.g., a network interface card or NIC) on the low diode node 16, but no further.

On the other side of the Flow Diode 2, and in like fashion, the receiver node 20 may be permitted (e.g., by software configuration) to use PING to test continuity back over the third link 19 from receiver process 28 to high diode process 26, but no further.

Neither the sender node 14 nor the receiver node 20 may be allowed or able to test continuity over the second link 17, in the center of the Flow Diode 2, between the low diode node 16 and the high diode node 18.

An indicator of whether the deep internals (e.g., the second link 17, the low diode node 16, and the high diode node 18) of the Flow Diode 2 are functioning properly may be provided to report forward (in the unidirectional flow of data) to a process on a node of higher security. For example, a voltage on a pin or a semaphore may be changed to indicate a status of the Flow Diode 2. The reporting of the status is always forward from low security to high security within the Flow Diode 2. In other words, the status of the nodes 14, 16, 18, 20 of the Flow Diode 2 can be reported in the direction of the destination network 12, such that the destination network 12 can learn the status of the functioning of the internals of the Flow Diode 2, but are not reported in the direction of the source network 10, such that the source network 10 cannot learn from the Flow Diode 2 the status of the functioning of the internals of the Flow Diode 2. In the illustrated embodiment, a pin 50 on a connector of the receiver node 20 is provided for access by the destination network 12. A voltage on the pin 50 may be raised if there exists a stateful malfunction within software or hardware on the Flow Diode 2. The stateful malfunction may result from a security attack (e.g., virus, malware, denial-of-service attack). As can be appreciated, the other nodes 14, 16, and 18 may also include a pin accessible by the next forward node, such that the next forward node can learn and further communicate forward the status indicated on such pin.

The Flow Diode 2 of FIG. 1 may be used in a role, or otherwise function, to create and/or ensure security of the destination network 12. Additional aspects, features, and methods of the Flow Diode 2 may enable additional roles that may enhance (and not dilute) this security role of the Flow Diode 2. The core processing capability of each of the four processors 14, 16, 18, 20 may be prioritized or otherwise configured for the security role of the Flow Diode 2 to enable improved control of performance quality. The additional functions, roles, and/or features of the Flow Diode 2 may include, but are not limited to: unidirectional data flow, fulfillment of a singular diode role, control over data flow, audit of data transmission, agility of function, coordination (e.g., to allow multiple data flow streams or to engage in security information transactions with other security components, such as a flow gate apparatus), greater throughput capacity, and continuous service.

The Flow Diode 2 of FIG. 1 is configured to provide unidirectional data flow. The functional components (e.g., the nodes 14, 16, 18, 20 and/or the processes 22, 24, 26, 28 implemented thereon) may be configured to enable a main execution sequence that implements a role to fulfil the overall security role of the Flow Diode 2 in a manner that provides unidirectional flow of data while allowing a classful procedural execution sequence.

In the communications protocols formalized by the Internet Engineering Task Force (IETF) Request for Comment (RFC) series, the majority of the protocols are transactional, meaning they use stateful two-way signaling across the data network, such that a sending computer process becomes aware of a distant destination process, and vice versa. The near and far computer processes which are involved in the transaction learn about each other and their parent systems to varying degrees. Unfortunately, in such processes lies the foundation of security problems.

By contrast, the functional components of the presently disclosed embodiments implement a unidirectional communication protocol that results in data flow in a single direction. For example, the unidirectional communication protocol may be similar to, but a modification of, the IETF Universal Datagram Protocol (UDP), or may be similar to, but a modification of, the IETF Trivial File Transfer Protocol (TFTP) which uses UDP to effectuate data flow in a single direction. In other words, the network connections between the nodes 14, 16, 18, 20 over the links 15, 17, 19 provide no network path from the destination network 12 back to the source network 10. The configuration of the nodes 14, 16, 18, 20 interrupts a direct electrical connection from the destination network 12 back to the source network and the internal configuration of the nodes 14, 16, 18, 20 limits or prevents signals back over the links 15, 17, 19. In certain embodiments, there may be absolutely no signals from the high diode node 18 back to the low diode node 16. In this manner, a unidirectional communication protocol is implemented that deterministically ensures that no transactional signaling is configured. As a result, while using the disclosed embodiments, it is not possible for a sending process on or coupled to the source network 10 to learn anything about a receiving process in the destination network 12, because there exists no reverse transmission channel, and no enablement of any signaling transaction. To the sending process in the source network 10, there is no “view” into the destination network 12. The destination network 12 remains undetectable.

The unidirectional communication protocol also may prohibit unauthorized external connection, such as to a standard TFTP and UDP client and server processes, on other networks.

The Flow Diode 2 of FIG. 1 is also configured to fulfill a singular diode role. In contrast with a “firewall router” configured with hundreds of security methods, the disclosed Flow Diode 2 can perform a single security method, namely as a strict unidirectional flow transmitter-receiver. A result is a deterministic security performance of high quality. Whatever code file (e.g., a malware executable) passes into a destination network 12 cannot “phone home” to the source network 10, because no return path exists. Further, the destination network 12 can be configured such that whatever code passes into a destination network cannot execute, as the destination computer may have been configured to not allow execution of any code other than authorized executables.

The Flow Diode 2 of FIG. 1 also may be configured to enable control over data flow. The Flow Diode 2 of FIG. 1 may provide for advanced code execution at each node 14, 16, 18, 20 and may be organized to allow post-compile definition of new data flow control features. This feature allows the security configuration to be changed as unanticipated security challenges emerge. For example, the data flow may be encrypted by various algorithms highly resistant to unauthorized code decryption. In one embodiment, the data contained in the information flow may be transformed to an ASCII text representation containing no binary control signaling, also known as “parameterless” information. In another embodiment, the data contained in the data flow may be transformed into a “BinHex” encoding, in which all native binary streams are simply converted to their hexadecimal equivalent and communicated as ASCII-encoded strings of hexadecimal characters. As still another example, the transmitted data frame size may be varied according to time of transmission and/or the numbered sequence of transmitted frames. The advanced code execution at each node 14, 16, 18, 20 may also enable advanced filtering of the data flow. For example, data blocks can be compared to known threats (e.g., executables such as viruses and other malware) and transmitted or removed as appropriate. As another example, filtering can be configured to allow certain types or classes of data to be passed and/or disallow certain types or classes of data from being passed. As another example, data from a particular source can be allowed (e.g., whitelist) or disallowed (e.g., blacklist) as desired.

The Flow Diode 2 of FIG. 1 also may be configured to enable audit of data transmission. The Flow Diode 2 may generate log files for auditing the security and/or performance of the Flow Diode 2. The generated log files may be specifically configured for support and/or audit specific performance standards, as required by, for example, customers using SCADA systems, regulators, and the like. Examples of log files configured for a standard may include:
a. Forensic Audit. A forensic audit log file can be configured to support law enforcement efforts requiring a time-stamped record of all transaction events over the Flow Diode system, including source addresses for RECEIVE actions, and destination addresses for SEND actions. The time-stamp may use a network time protocol (NTP) clock for purposes of comparison with other logs from computers on the same NTP server.
b. Health Insurance Portability and Accountability Act (HIPAA) Audit. A HIPAA audit log file can be configured to support HIPAA inspection of network security compliance with specific HIPAA performance requirements.
c. North-American Electric Reliability Corporation (NERC) Audit. A NERC audit log file can be configured to provide information required of power utilities by the Critical Infrastructure Protection (CIP) Standards.
d. U.S. Dept. of Transportation, Pipeline and Hazardous Materials Safety Administration (PHMSA) Audit. A PHMSA audit log file can be configured to support federal programmatic inspections of pipeline operator management systems, procedures, and processes.
e. Service Level Agreement-Quality of Service (SLA-QoS) Audit. An SLA-QoS audit log file can be configured to record compliance of performance with a Service Level Agreement which is defined by quantitative quality-of-service indices.

The transmission audit capability may also provide multiple different levels of debug log file configuration (e.g., log levels) to facilitate debugging transmission issues. The debug log files may record low-level function and/or class call events, including error events.

If a provider utility claims deterministic network security performance then fulfillment of this service level guarantee may be required to a degree that is forensically provable, else there exists no unambiguous quality-of-service. Embodiments of a Flow Diode sender process and a Flow Diode receiver process can be independently configured for audit capability to accomplish proving a given service level guarantee.

Many organizations must meet security requirements for computer networks and network flows. Pre-configured audit capability of the disclosed embodiments can enable provable compliance with a variety of security standards.

Many organizations require periodic audits of information flow for their own operations' policies and procedures. Pre-configured forensic audit capability of the disclosed embodiments can enable periodic audit requirements to be met.

Many organizations require audit capability upon the occurrence of a security event in their network. Pre-configured audit capability of the disclosed embodiments can enable on-call forensic audits to investigate or otherwise address a security event.

The Flow Diode 2 of FIG. 1 also may be configured to enable agility of function. It is not possible to anticipate all forms of future attack upon computers and networks. The internals of the disclosed embodiments may be upgraded. For example, a proprietary classful library supporting the Java executable on a given node 14, 16, 18, 20 may be changed to enable new capability. This agility is a feature of the disclosed embodiments not presently available in existing flow diodes.

The Flow Diode 2 of FIG. 1 also may be configured to enable two forms of coordination: coordinating transmission of multiple streams to a destination on the destination network and coordinating with other security components.

One form of coordination is to allow multiple information flow streams from source networks to use a single apparatus to communicate to a destination network. This form of coordination can be implemented on the sender node 14. A plurality of sender nodes 14 (or a plurality of CPUs and/or processing devices within a sender node 14) may be stacked in parallel as a single sender node 14 to receive multiple streams of data and coordinate transmission of a single stream of data to the low diode node 16.

A second new form of coordination allows the disclosed embodiments to engage in security information transactions with, for example, another security device, such as a flow gate apparatus, located on an outboard, commodity Internet-facing side of a firewall system of an organization. In this form of coordination, a security information transaction may include information and/or signals being communicated to another security device (or multiple other security devices). This second form of coordination may be implemented on the sender node 14 and can enhance the ability to respond effectively to a frequent form of computer network attack, a Denial-of-Service attack. Coordination may, in certain embodiments, involve stacking a plurality of the disclosed systems and/or apparatus in parallel and sending a “keep alive signal” from a primary apparatus to a secondary or backup apparatus.

The Flow Diode 2 of FIG. 1 also may be configured to enable increased throughput capacity. The disclosed embodiments may utilize copper and optical fiber network interfaces, which may accept copper bandwidth of up to 1 Gbps and optical bandwidth of up to 100 Gbps.

The Flow Diode 2 of FIG. 1 also may be configured to provide continuous service. The disclosed embodiments may provide a unique computer and operating system configuration and a unique physical configuration which provides high availability security performance, and in-line fail-over capability to a redundant disclosed embodiment. As an example, a plurality of the disclosed systems and/or apparatus may be stacked in parallel, with one primary apparatus and one or more secondary or backup apparatus.

In one embodiment, the nodes 14, 16, 18, 20 may each be implemented on a computing system (e.g., a personal computer, a server, or the like) on which mature computer operating systems and system resources may be used in combination with mature high-level languages and their libraries to enable and configure granular control of the information flow in the processes 22, 24, 26, 28 executed by the nodes 14, 16, 18, 20. In such embodiments, each node 14, 16, 18, 20 may include a processor. The Flow Diode 2 may include four nodes 14, 16, 18, 20.

In the illustrated embodiment of FIG. 1, four nodes 14, 16, 18, 20 do not require system clock synchronization. An Ethernet framing protocol may be used over the three network links 15, 17, 19 between the four nodes 14, 16, 18, 20. The Ethernet framing protocol is fundamentally asynchronous, and does not require the higher complexity and cost of bit-wise clock synchrony. In another embodiment, the four nodes 14, 16, 18, 20 (e.g., processors of each of the nodes) may be synchronized with a system clock.

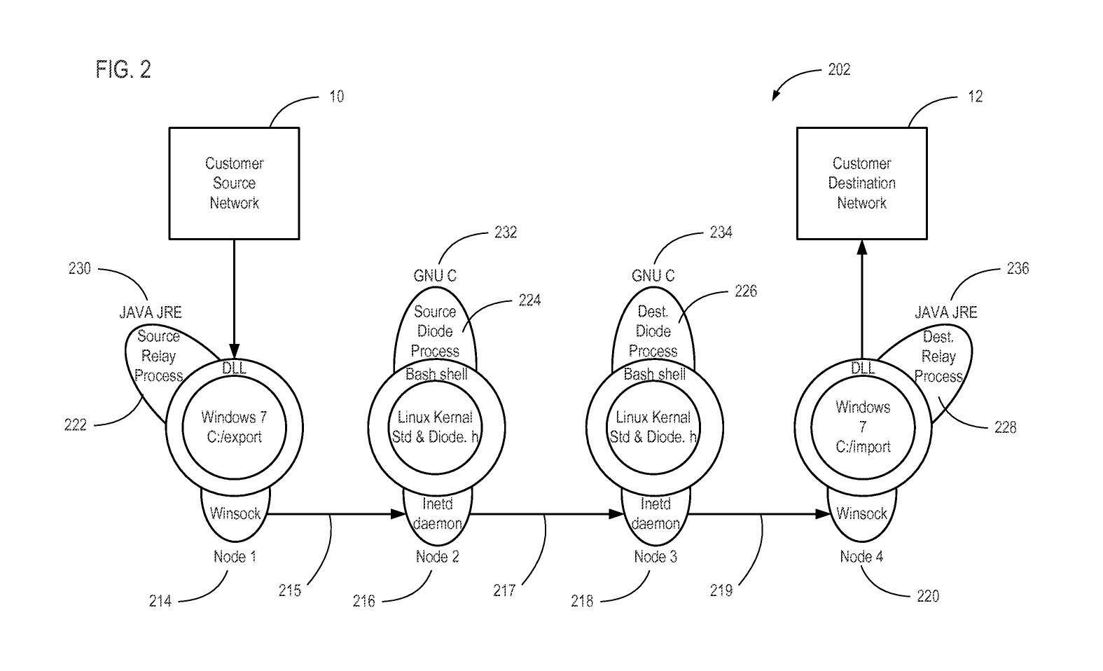

FIG. 2 provides a functional block diagram of an example implementation of a Flow Diode 202, according to an embodiment of the present disclosure. FIG. 2 portrays computer and operating system topology and software resources and illustrates singular controlled unidirectional flow of data or information across the Flow Diode 202. For example, mature computer operating systems and system resources may be used in combination with mature high-level languages and their libraries to enable and configure granular control of the information flow in processes executed by a plurality of nodes 214, 216, 218, 220 or processors. FIG. 2 shows an example of a source of resources of the Flow Diode 202.

In the embodiment of FIG. 2, a recent stable release of, for example, the Microsoft® Windows® 7 operating system may be deployed on the sender node 214, for reasons of compatibility with likely customer computer systems to be encountered in public utility SCADA networks. In like fashion and for similar reasons, the receiver node 220 may include a deployment of the Microsoft Windows 7 operating system. In certain other embodiments, other suitable operating systems may be deployed.

In the embodiment of FIG. 2, on the sender node 214, which may be dedicated to a sender process 222, the Oracle Java Runtime Environment, Java JRE 230, may be deployed for reasons of portability, high security, and complete library support. The executable forms of “applet” and “servlet” may not be included or used. Computer-executable instructions for the sender process 222 may be provided in an executable, which may be a straightforward Java program compiled in the form of bytecode to be executed by the Java Virtual Machine (not depicted). The executable may perform a server process that may provide unidirectional datagram service over a network link 215 from the sender node 214 to the low diode node 216 upon demand until explicitly stopped. “Upon demand” may mean upon the arrival of a data block (e.g., a file) from the source network 10, for example, into an export directory on or accessible by the sender node 214. Upon demand may also include providing service upon arrival of a signal indicating arrival of a data block from a source network 10. In order to adhere to strict unidirectional transmission, the sender process 222 may be prevented from or otherwise cannot detect (or “see”) a receiver process 228 on the receiver node 220 at the other side of the Flow Diode 202. Rather, the data blocks sent by the sender process 222 may be received, e.g., at a network interface of the low diode node 216, and written to a directory, file, or other location on the low diode node 216 without any return data, information, or signals back to the sender node 214. Receive and send functions may be implemented on the sender node 214 by the operating system, such as by software control of the onboard Windows Winsock server, generally a continuous server process, which can provide Open System Interconnect network protocol service on interconnected network media.

In the embodiment of FIG. 2, on the receiver node 220, which may be dedicated to a receiver process 228, the Oracle Java Runtime Environment, Java JRE 236, may be deployed in similar fashion. Computer-executable instructions for the receiver process 228 may be provided in an executable, which may be a straightforward Java program compiled in the form of bytecode and executed by the Java Virtual Machine (not depicted). The executable may perform a server process which may provide unidirectional datagram service to the destination network 12 upon demand until explicitly stopped. “Upon demand” may mean upon the arrival of a data block (e.g., a file), for example, in the C:\Import directory on the receiver node 220. Upon demand may also include providing service upon arrival of a signal indicating arrival of a data block from the high diode node 218. Due to strict unidirectional transmission the receiver process 228 does not and cannot provide any signaling back to a sending node or process. In other words, in the illustrated embodiment of FIG. 2 the receiver process 228 may be restricted or prevented from providing any signal or data back to the high diode node 218 or the high diode process 226, whether via the network link 219 or other network link. Receive and send functions on the receiver node 220 may be implemented by the operating system, such as by software control of the onboard Windows Winsock server, a continuous server process, which provides Open System Interconnect network protocol service on interconnected network media.

The internals of the Flow Diode 202 in FIG. 2 lie between the sender node 214 and the receiver node 220 and may include the low diode node 216 and the high diode node 218. The internals of the Flow Diode 202 may also include the network links 215, 217, and 219. The low diode node 216 and the high diode node 218 may host internal diode processes utilizing network methods and may be implemented by a stable computer operating system of demonstrable high availability and continuous function.

For example, in FIG. 2, the low diode node 216 may be dedicated to a low diode process 224. Computer-executable instructions for the low diode process 224 may be provided in an executable, such as a GNU C 232 executable, which may be deployed for reasons of straightforward, linear process-oriented computation, and robust library support. The executable may be a relatively straightforward C program compiled in the form of an executable binary image, and may be executed directly by an onboard Linux operating system deployed on the low diode node 216. The executable may perform a server process that provides unidirectional datagram service forward over the network link 217 from the low diode node 216 to the high diode node 218 upon demand until explicitly stopped. “Upon demand” may mean upon the arrival of a data block (e.g., a file) from the sender node 214, for example, into an associated directory on the low diode node 216. Upon demand may also include providing service upon arrival of a signal indicating arrival of a data block from the sender node 214. Receive and send functions on the low diode node 216 may be implemented by the operating system, such as by software control of the onboard Linux inetd daemon (continuous server process) which provides Open System Interconnect network protocol service on interconnected network media. As can be appreciated, in other embodiments, other suitable operating systems may be deployed and other types of C or other programming languages may be provided.

Further, in FIG. 2 the high diode node 218 may be dedicated to the high diode process 226. Computer-executable instructions for the high diode process 226 may be provided in an executable, such as a GNU C 234 executable, which may be deployed for reasons of straightforward, linear process-oriented computation, and robust library support. The executable may be a straightforward C program compiled in the form of an executable binary image, and may be executed directly by an onboard Linux operating system. The executable may perform a server process that provides unidirectional datagram service forward over the network link 219 from the high diode node 218 to the receiver node 220 upon demand until explicitly stopped. “Upon demand” may mean upon the arrival of a data block (e.g., a file) from the low diode node 216 into an associated directory on the high diode node 218. Upon demand may also include providing service upon arrival of a signal indicating arrival of a data block from the low diode node 216. Receive and send functions on the high diode node 218 may be implemented by the operating system, such as by software control of the onboard Linux inetd daemon (continuous server process) which provides Open System Interconnect network protocol service on interconnected network media. As can be appreciated, in other embodiments, other suitable operating systems may be deployed and other types of C or other programming languages may be provided.

The architecture of the embodiments of FIGS. 1 and 2, and other disclosed embodiments, may allow scalability, such that more than one sender node 214 dedicated to a sender process may be acceptable and deployable in a Flow Diode. Multiple sender nodes 214 in parallel may enable increased throughput capacity.

In other embodiments, the operating system topology and the software resources on the sender node 214 and/or the receiver node 220 may be similar or identical to those of the low diode node 216 and/or the high diode node 218. In other words, the sender node 214 and/or the receiver node 220 may include a deployment of the Linux operating system with GNU C executables implemented or otherwise executed thereon. Similarly, in still other embodiments, the low diode node 216 and/or the high diode node 218 may include a deployment of the Microsoft® Windows® 7 operating system and the Oracle Java Runtime Environment, Java JRE to execute Java programs. The operating system topology and/or the software resources may be any appropriate type and/or arrangement to support a physical configuration that includes multiple nodes coupled by links in between and implementing a unidirectional flow of data.

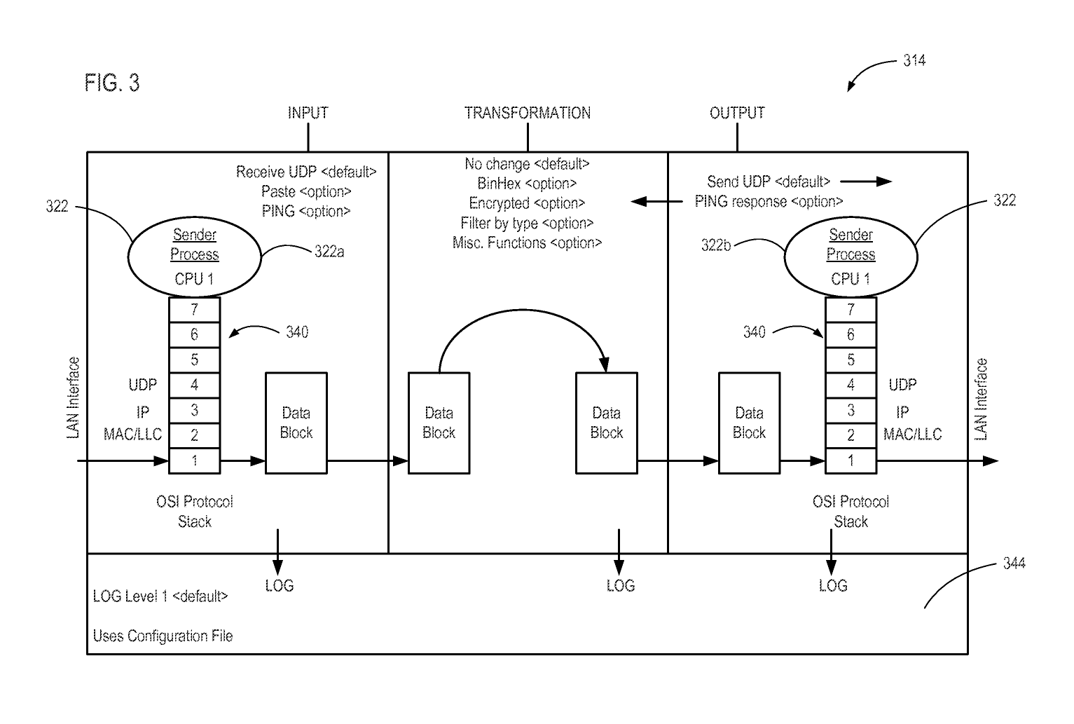

FIGS. 3, 4, 5, and 6 describe an Input-Transformation-Output (ITO) sequence at each of four nodes in a Flow Diode system or apparatus, according to one embodiment.

FIG. 3 is a flow diagram depicting an ITO sequence across a sender node 314 of a Flow Diode, according to one embodiment. A sender process 322 performed on the sender node 314 may execute and exert control of receive actions using a network protocol stack 340. The receive actions may be UDP receive actions. The stack 340 may be, for example, a Winsock stack process, the Microsoft Windows 7 operating system embodiment of the seven-layer Open Systems Interconnect (OSI) Protocol Stack (ITU-T X.200 Standard). The complete transmit-receive transaction across an incoming link may be accomplished through the stack 340 by a modified version of IETF TFTP, using innovative code modification for the desired function. For example, the protocol may differ from TFTP and other presently available protocols in that return acknowledgements back to a sending process are limited in number and/or in data transmitted from the receiving process back to the sending process.

In the embodiment of FIG. 3, a data block may be received electronically on the sender node 314 at the physical layer of the stack 340, as indicated by the arrow into the first layer of the stack 340. However, the data block may also be received logically at one or more higher levels (i.e., layers 2-7) of the stack 340. As an example, the sender process 322 may include a TFTP daemon or similar server process 322a, which may run on top of a UDP layer of the stack, which may run on top of an IP layer of the stack, and so on. The data block may be written to a physical storage medium and may be present at the physical storage medium throughout the ITO sequence. When the transfer of the data block is complete, an entry may be written to a log file 344 of the sender node 314. The log entry may include a time stamp from a common clock (a clock synchronized with clocks of the other nodes of the diode, including the low diode node, the high diode node, and the receiver node). The log entry may include status information, for example, concerning the success of the transfer.

In the transformation phase of the ITO sequence, the data block may be transformed or otherwise processed. The sender process 322 may, for example by default, not perform any transformation of the data block or may provide BinHex transformation, encryption, and/or filtering. As noted, the default transformation may be no action. Optional BinHex encoding may be configured. Optional secure encryption may be configured. The modules (e.g., Java objects) which may accomplish the transformation may be consistent with the CERT Oracle Secure Coding Standard for Java. The transformation is performed by the sender process 322 which may be executed by the Oracle Java Virtual Machine (not depicted) in the Windows 7 operating system on the sender node 314.

The sender process 322 and/or sender node 314 are configured to provide agility. In other words, the architecture of the sender process 322 and/or sender node 314 may enable inclusion of additional modules, to perform miscellaneous functions or other transformations on the data block, such that expansion of the possible transformation options is possible. For example, a module may be included that filters data by type. The filter module may remove undesired data blocks, such as executables. The filter module may remove from the data stream any data blocks which may be dangerous or pose a threat to the destination (e.g., high-security) network. The filter module may be configurable. The agility that is possible in the disclosed embodiments is expressed in the functional organization of the sender process 322. When new forms of cyber-attack emerge, or requirements for other new functionality arise, the agile object-oriented classful design of the runtime code may enable implementation of new capability. The sender process 322 is positioned at the start of the information data flow across a Flow Diode. Strategically this is a suitable position from which to manipulate the content and flow across the Flow Diode. The sender process 322 may include or have access to a library of functions that may be callable from the runtime environment. For example, a proprietary “Diode.h” library of classes may be “callable” from the Java Runtime Environment. The library of classes may be easily and securely manipulated, easily upgraded without disruption of continuous function, and easily changed or added to implement new security actions on the data flow.

In the embodiment of FIG. 3, upon completion of transformation of the data block, an entry may be written to the log file 344. The log entry may include a time stamp from the common clock. The log entry may also include status information, for example, concerning the success of the transformation options.

Also, upon completion of transformation of the data block, the sender process 322 may automatically send the data block outbound through the protocol stack 340, such as through an OSI stack process, as previously described. The sender process 322 may include a TFTP client or similar client process 322b. The sender process 322 may also be used to PING an immediately downstream process and/or node, such as a low diode process and/or low diode node, but cannot PING any further downstream, nor across a core link (e.g., a link between the low diode node and the high diode node) of the Flow Diode.

As previously noted, in the embodiment of FIG. 3, the sender process 322 may generate a log file 344 configured to enable a transmission audit feature. The log file 344 may be configurable to be specific to security events. The log file 344 may be configurable to be formatted according to audit requirements of a specific industry. As noted, entries may be written to the log file 344 at one or more points during the ITO sequence, such as after the receipt transfer, after a transformation, and/or before a send transfer. The log file 344 of the sender process 322 on the sender node 314 may be correlated with and/or compared with a log file of a receiver process on a receiver node, as described below.

One or more configuration files 346 may provide configuration settings for a runtime environment of the sender node 314 and/or the sender process 322. The configuration files 346 may be modified by a user to change configuration settings and, in turn, the runtime environment of the sender node 314.

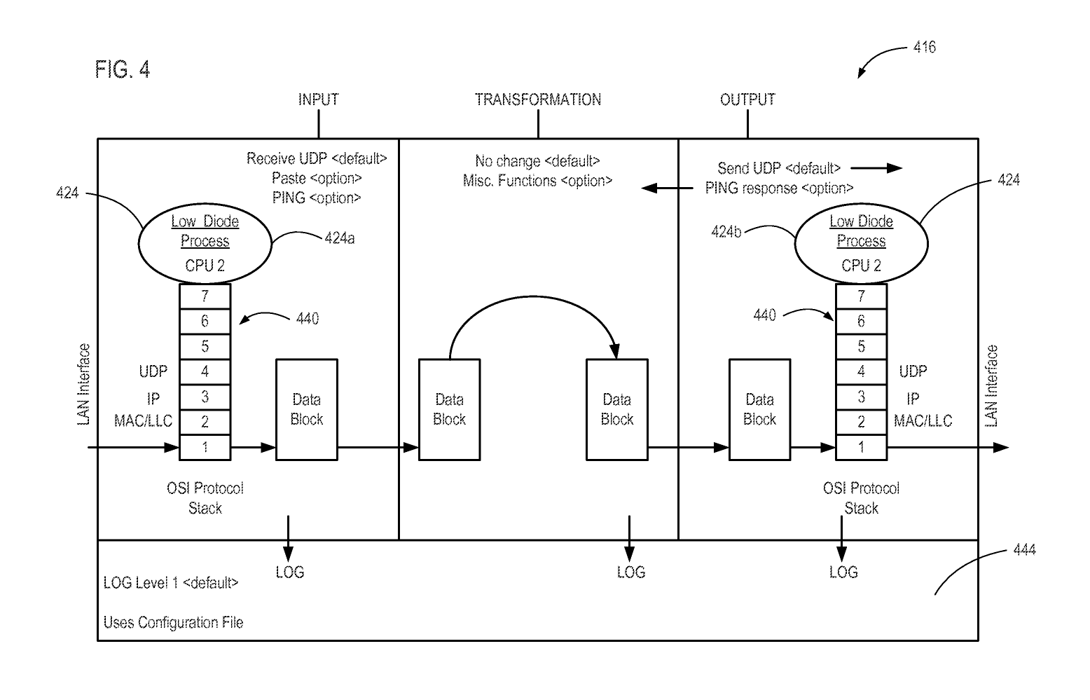

FIG. 4 is a diagram of an ITO sequence across a low diode node 416 of a Flow Diode, according to one embodiment. A low diode process 424 performed on the low diode node 416 may execute and exert control of receive actions using a network protocol stack 340. The receive actions may be UDP receive actions. The stack 340 may be, for example, the “Berkeley Sockets stack” process in the inetd daemon, the Linux operating system embodiment of the seven-layer Open Systems Interconnect Stack (ITU-T X.200 Standard). The complete transmit-receive transaction across the incoming link may be accomplished by a modified version of IETF TFTP, using innovative code modification for optimal function.

A data block may be received electronically on the low diode node 416 at the physical layer of the stack 440, as indicated by the arrow into the first layer of the stack 440. However, the data block may also be received logically at one or more higher levels (levels 2-7) of the stack 440. As an example, the low diode process 424 may include a TFTP daemon or similar server process 424a, which may run on top of a UDP layer of the stack, which may run on top of an IP layer of the stack, and so on. The data block may be written to a physical storage medium and may be present at the physical storage medium throughout the ITO sequence. When the transfer of the data block to the low diode node 416 is complete, an entry may be written to a log file 444 of the low diode node 416. The log entry may include a time stamp from a common clock (a clock synchronized with clocks of the other nodes of the diode, including the low diode node, the high diode node, and the receiver node). The log entry may include status information, for example, concerning the success of the transfer.

The low diode process 424 of the disclosed embodiment may not enable transformation of the data block. In other words, the default transformation of the low diode process is no action, other than basic relay. The data block may not be changed.

In other embodiments, the low diode process 424 may enable transformation of the data block, such as transformations described above with reference to FIG. 3 and the sender process 322. The architecture of the low diode process 424 and/or low diode node 416 may enable inclusion of additional modules, to perform miscellaneous functions or other transformations on the data block, such that expansion of the possible transformation options is possible. The low diode process 424 and/or low diode node 416 are configured to provide agility. The agility that is possible in the disclosed embodiments is expressed in the function organization of the low diode process 424. When new forms of cyber-attack emerge, or requirements for other new functionality arise, the agile object-oriented classful design of the runtime code may enable implementation of new capability.

In the embodiment of FIG. 4, upon receiving the data block, the low diode process 424 may automatically send the data block outbound through the “Berkeley Sockets stack” process, as previously described. The low diode process 424 may include a TFTP daemon or similar server process 424b. The server process 424a and the server process 424b illustrated in FIG. 4 may be the same server process, identical server processes, or different server processes. The low diode process 424 may also be used to respond to a PING from an immediately upstream process and/or node, such as the sender process 322 and/or sender node 314 (FIG. 3), but cannot PING any further upstream, nor downstream across the core link of the Flow Diode.

The core link of a Flow Diode is a link from the low diode node 416 downstream to a high diode. The core link can easily be physically unplugged, or a similar such unambiguous disconnection can be made, to isolate and separate the destination network from the source network.

In the embodiment of FIG. 4, the low diode process 424 may generate a log file 444 configured to enable a transmission audit feature. The log file 444 may be configurable to be specific to security events. The log file 444 may be configurable to be formatted according to audit requirements of a specific industry, as described above with reference to the sender node 314 in FIG. 3.

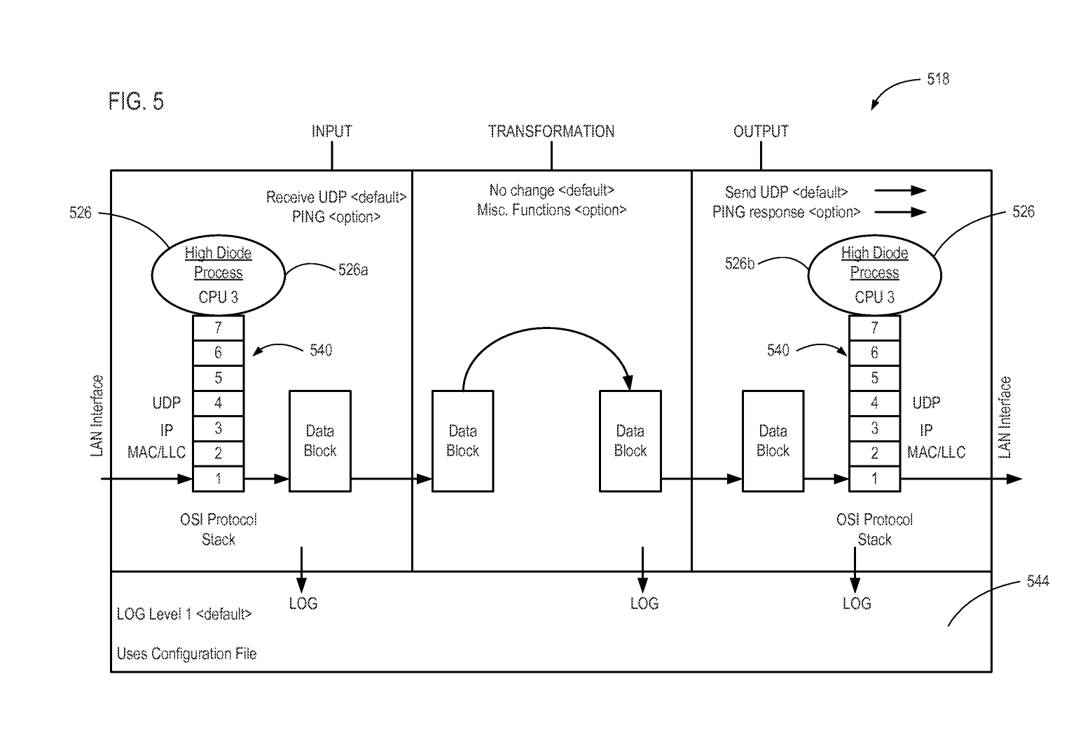

FIG. 5 is a diagram of an ITO sequence across a high diode node 518 of a Flow Diode, according to one embodiment. A high diode process 526 performed on the high diode node 518 may execute and exert control of receive actions using a network protocol stack 540. The receive actions may be UDP receive actions. The stack 540 may be, for example, the “Berkeley Sockets stack” process in the inetd daemon, the Linux operating system embodiment of the seven-layer Open Systems Interconnect Stack (ITU-T X.200 Standard). The complete transmit-receive transaction across the incoming link may be accomplished through the stack 340 by a modified version of IETF TFTP, using innovative code modification for optimal function.

A data block may be received electronically on the high diode node 518 at the physical layer of the stack 540, as indicated by the arrow into the first layer of the stack 540. However, the data block may also be received logically at one or more higher levels (i.e., layers 2-7) of the stack 540. As an example, a high diode process 526 may include a TFTP client or similar client process 526a, which may run on top of a UDP layer of the stack, which may run on top of an IP layer of the stack, and so on. The data block may be written to a physical storage medium and may be present at the physical storage medium throughout the ITO sequence. When the transfer of the data block is complete, an entry may be written to a log file 544 of the high diode node 518. The log entry may include a time stamp from a common clock (a clock synchronized with clocks of the other nodes of the diode, including the low diode node, the high diode node, and the receiver node). The log entry may include status information, for example, concerning the success of the transfer.

The high diode process 526 of the disclosed embodiment may not enable transformation of the data block. In other words, the default transformation of the high diode process 526 is no action, other than basic relay. The data block may not be changed.

In other embodiments, the high diode process 526 may enable transformation of the data block, such as transformations described above with reference to FIGS. 3 and the sender process 322. The architecture of the high diode process 526 and/or the high diode node 518 may enable inclusion of additional modules, to perform miscellaneous functions or other transformations on the data block, such that expansion of the possible transformation options is possible. The high diode process 526 is configured to provide agility. The agility that is possible in the disclosed embodiments is expressed in the function organization of the high diode process 526. When new forms of cyber-attack emerge, or requirements for other new functionality arise, the agile object-oriented classful design of the runtime code may enable implementation of new capability.

In the embodiment of FIG. 5, upon receiving the data block, the high diode process 526 may automatically send the data block outbound through the “Berkeley Sockets stack” process, as previously described. The high diode process 526 may include a TFTP client or similar client process 526b. The client process 526a and the client process 526b illustrated in FIG. 5 may be the same client process, identical client processes, or different server processes. In other words, the high diode node 518 may include a single client process (e.g., client process 526a) or two separate client processes (e.g., client processes 526a, 526b) and does not include a daemon or server process. Thus, the low diode node 416 (and a corresponding low diode process 424) cannot see or otherwise be aware of a receiver node beyond the high diode node 518.

The high diode process 526 may also be used to respond to a PING from an immediately downstream process and/or node, such as a receiver process or receiver node, but cannot PING any further downstream, nor backwards across the core link of the Flow Diode.

In the embodiment of FIG. 5, the low diode process 526 may generate a log file 544 configured to enable a transmission audit feature. The log file 544 may be configurable to be specific to security events. The log file 544 may be configurable to be formatted according to audit requirements of a specific industry, as described above with reference to the sender node 314 in FIG. 3.

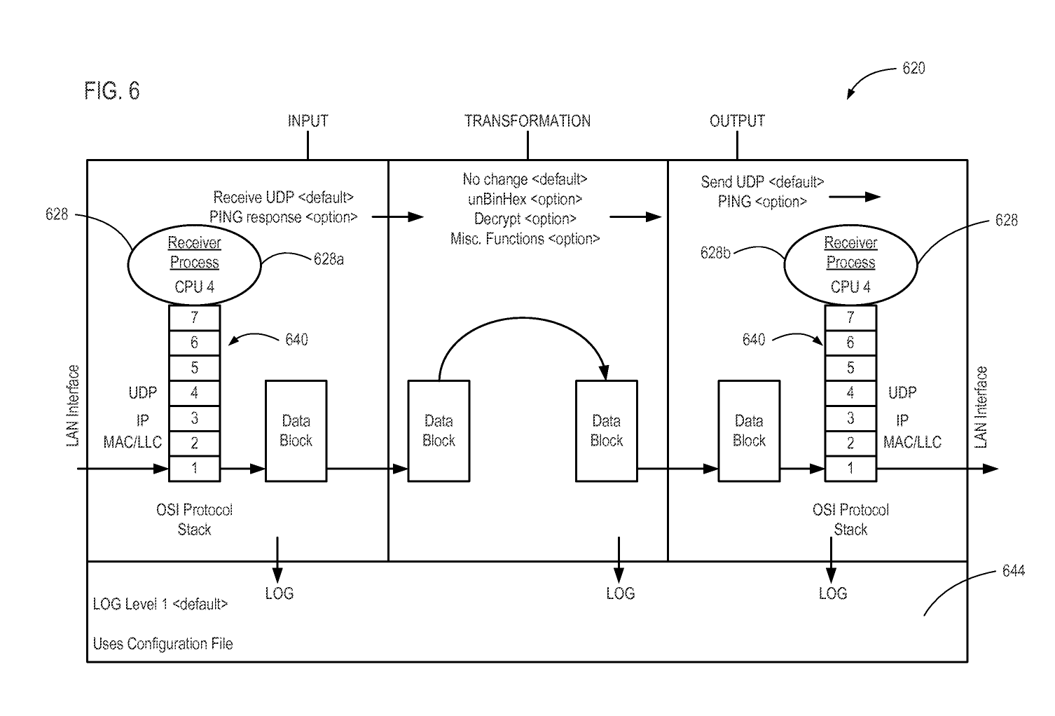

FIG. 6 is a diagram of an ITO sequence across a receiver node 620 of a Flow Diode, according to one embodiment. A receiver process 628 performed on the receiver node 620 may execute and exert control of receive actions using a network protocol stack 640. The receive actions may be UDP receive actions. The stack 640 may be, for example, the Winsock stack process, the Microsoft Windows 7 operating system embodiment of the seven-layer Open Systems Interconnect Stack (ITU-T X.200 Standard). The complete transmit-receive transaction across the incoming link may be accomplished by a modified version of IETF TFTP, using innovative code modification for optimal function.

In the embodiment of FIG. 6, a data block may be received electronically on the receiver node 620 at the physical layer of the stack 640, as indicated by the arrow into the first layer of the stack 640. However, the data block may also be received logically at one or more higher levels (i.e., layers 2-7) of the stack 640. As an example, the receiver process 628 may include a TFTP daemon or similar server process 628a, which may run on top of a UDP layer of the stack, which may run on top of an IP layer of the stack, and so on. The data block may be written to a physical storage medium and may be present at the physical storage medium throughout the ITO sequence. When the transfer of the data block is complete, an entry may be written to a log file 644 of the receiver node 620. The log entry may include a time stamp from a common clock (a clock synchronized with clocks of the other nodes of the diode, including the low diode node, the high diode node, and the receiver node). The log entry may include status information, for example, concerning the success of the transfer.

During the transformation phase of the ITO sequence, the receiver process 628 may enable transformation of the data block. For example, the receiver process 628 may reverse a transformation of the sender process 322 (FIG. 3). The receiver process 628 may, for example by default, not perform any transformation of the data block or may provide unBinHex transformation or decryption, depending on earlier transformations. The modules (e.g., Java objects) which may accomplish the transformation may be consistent with the CERT Oracle Secure Coding Standard for Java. The transformation is performed by the receiver process 628 which may be executed by the Oracle Java Virtual Machine (not depicted) in the Windows 7 operating system on the receiver node 620.

The receiver process 628 and/or receiver node 620 are configured to provide agility. In other words, the architecture of the receiver process 628 and/or receiver node 620 may enable inclusion of additional modules, to perform miscellaneous functions or other transformations on the data block, such that expansion of the possible transformation options is possible. The agility that is possible in the disclosed embodiments is expressed in the function organization of the high diode process 628. When new forms of cyber-attack emerge, or requirements for other new functionality arise, the agile object-oriented classful design of the runtime code may enable implementation of new capability.

In the embodiment of FIG. 6, upon completion of transformation of the data block, an entry may be written to the log file 644. The log entry may include a time stamp from the common clock. The log entry may also include status information, for example, concerning the success of the transformation options.

Also, upon completion of transformation of the data block, the receiver process 628 may automatically send the data block outbound through an OSI stack process, as previously described, onward to a first computer in the destination network (e.g., a customer high-security network). The receiver process 628 may also be used to PING an immediately upstream process and/or node, such as the high diode process 526 and/or high diode node 518 (FIG. 5), but cannot PING any further upstream, nor across the core link of the Flow Diode.

In the embodiment of FIG. 6, the receiver process 628 may generate a log file configured to enable a transmission audit feature. The log file may be configurable to be specific to security events. The log file may be configurable to be formatted according to audit requirements of a specific industry. Correlation of the receiver process 628 log file 644 and the sender process 322 log file 344 may allow forensic provability of network security performance provided by the disclosed embodiments of a Flow Diode. Through correlating the receiver process 628 log file 644 and the sender process 322 log file 344, which may be based on a synchronous clock, at least between the sender node 314 and the receiver node 320, performance metrics can be determined and/or gathered. For example, how long it takes for a data block to be passed through the Flow Diode can be determined, tracked, and monitored. Similarly, congestion of the Flow Diode can be monitored.

Through sequential ITO actions, for example, depicted in FIGS. 3 through 6, the disclosed embodiments provide a controlled unidirectional flow of data that can maintain a high level of security for a computer network.

The disclosed embodiments may further provide a coordination interface to receive and transmit coordination messages to other security components, such as a flow gate. For example, the disclosed embodiments may be positioned behind a network firewall of a destination (e.g., high-security) network. The disclosed embodiments may receive alerts from a flow gate component positioned outside the network firewall. The alerts may indicate a potential security threat. Similarly, the disclosed embodiments may communicate messages to the flow gate component, for example, regarding potentially suspicious packets or activity for which the flow gate may be well suited to monitor.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present invention should, therefore, be determined by the following claims.

We claim:

1. An apparatus for providing unidirectional flow of data from a source network to a destination network, the apparatus comprising:
a sender node to receive a block of data from a source computer network, manage movement of the block of data from the sender node, and transfer the block of data;
a low diode node to receive the block of data from the sender node, manage movement of the block of data from the low diode node, and transfer the block of data;
a high diode node to receive the block of data from the low diode node, manage movement of the block of data from the high diode node, and transfer the block of data; and
a receiver node to receive the block of data from the high diode node, manage movement of the block of data from the receiver node, and transfer the block of data from the receiver node to a destination network,
wherein the apparatus prohibits flow of destination network data to the source network.

2. The apparatus of claim 1, wherein the sender node is configured to perform a transformation of the data block.

3. The apparatus of claim 2, and wherein the receiver node is configured to reverse the transformation of the data block performed by the sender node.

4. The apparatus of claim 1, wherein the sender node is configured to perform a function on the data block.

5. The apparatus of claim 1, wherein the sender node is configured to perform one or more functions of a plurality of functions on the data block.

6. The apparatus of claim 5, wherein the one or more functions include filtering, such that the data block is removed from the data stream if the data block is of a pre-determined type.

7. The apparatus of claim 5, wherein the sender node is configured such that the plurality of functions is expandable to include additional functions.

8. The apparatus of claim 1, wherein the sender node is configured to generate a first configurable log file specific to security events.

9. The apparatus of claim 8, wherein the first configurable log file is configurable according to an audit format of a specific industry.

10. The apparatus of claim 1, wherein the receiver node is configured to generate a second configurable log file specific to security events.

11. The apparatus of claim 10, wherein the second configurable log file is configurable according to an audit format of a specific industry.

12. The apparatus of claim 1, wherein the sender node is configured to generate a first log file specific to security events, wherein the receiver node is configured to generate a second log file specific to security events, wherein the receiver node correlates the first log file and the second log file.

13. The apparatus of claim 1, further comprising a keep-alive output configured to communicate a signal to an adjacent stacked apparatus for providing a controlled unidirectional data flow from the source network to the destination network, the signal indicating the each of the sender node, the low diode node, the high diode node, and the receiver node is operating appropriately.

14. The apparatus of claim 1, comprising a plurality of sender nodes integrated to process multiple data streams and provide a single data stream to the low diode node.

15. The apparatus of claim 1, further comprising a network link between the low diode node and the high diode node, wherein the link is unidirectional such that a data block can be transmitted from the low diode node over the network link to the high diode node and the high diode node is incapable of transmitting data to the low diode node.

16. A method for providing unidirectional flow of data from a source network to a destination network, the method comprising:
receiving a block of data at a sender node from the source network, the sender node linked to a low diode node via a first link;
processing the block of data on the sender node;
generating a sender node log file;
transferring the block of data from the sender node to the low diode node via the first link;
receiving the block of data at the low diode node from the sender node, the low diode node linked to a high diode node via a second link;
transferring the block of data from the low diode node to the high diode node via the second link;
receiving the block of data at the high diode node from the low diode node, the high diode node linked to a receiver node via a third link;
transferring the block of data from the high diode node to the receiver node via the third link;
receiving the block of data at the receiver node from the high diode node, the receiver node linked to the destination network;
processing the block of data on the receiver node;
generating a receiver node log file;
transferring the block of data from the receiver node to the destination network; and
prohibiting flow of destination network data to the source network.

17. The method of claim 16, wherein each of one or more of the first link, the second link, and the third link is a unidirectional link.

18. The method of claim 16, wherein processing the block of data on the sender node comprises a transformation of the block of data, and wherein processing the block of data on the receiver node comprises reversing the transformation of the block of data.

19. The method of claim 16, further comprising:
transforming the block of data on the sender node from a first data format to a second data format; and
transforming the block of data on the receiver node from the second data format to the first data format.

20. The method of claim 16, wherein the sender node log file and the receiver node log file are configurable to comply with audit requirements of an industry.

21. The method of claim 16, further comprising correlating the sender node log file and the receiver node log file to audit performance standards.

22. The method of claim 16, further comprising generating one or more of a low diode node log file and a high diode node log file.

23. A system for providing unidirectional flow of data from a source network to a destination network, the system including a plurality of interconnected computing devices, comprising:
a sender node including a source network interface to receive a block of data from a source computer network, a sender processor to manage processing of the block of data on the sender node, and a low diode interface to transfer the block of data from the sender node;
a low diode node including a sender node interface to receive the block of data from the sender node, a low diode processor to manage processing of the block of data on the low diode node, and a high diode node interface to transfer the block of data from the low diode node;
a high diode node including a low diode node interface to receive the block of data from the low diode node, a high diode processor to manage processing of the block of data on the high diode node, and a receiver node interface to transfer the block of data from the high diode node; and
a receiver node including a high diode node interface to receive the block of data from the high diode node, a receiver processor to manage processing of the block of data on the receiver node, and a destination network interface to transfer the block of data from the receiver node to a destination network,
wherein the apparatus prohibits flow of destination network data to the source network.

24. The system of claim 23, wherein the sender node is configured to perform a transformation of the data block.

25. The system of claim 24, and wherein the receiver node is configured to reverse the transformation of the data block performed by the sender node.
